(19) United States
(12) Patent Application Publication
(10) Pub. No.: US 2014/0150069 A1
(43) Pub. Date: May 29, 2014

(54) METHOD FOR DISTINGUISHING AND BLOCKING OFF NETWORK NODE

(71) Applicant: SOFNET CORPORATION, Taipei City (TW)

(72) Inventor: KUN-JUNG LEE, TAIPEI CITY (TW)

(73) Assignee: SOFNET CORPORATION, Taipei City (TW)

(21) Appl. No.: 13/763,673

(22) Filed: Feb. 9, 2013

(30) Foreign Application Priority Data
Nov. 26, 2012 (TW) 101144201

(51) Int. Cl. H04L 29/06

(52) U.S. Cl. CPC H04L 63/10
USPC 726/4

(57) ABSTRACT

The invention provides a method for distinguishing and blocking off a network node. The method includes a packet receiving step and a packet distinguishing processing step. The packet receiving step is provided for receiving an ARP packet from a network node within a network segment. The packet distinguishing processing step is provided for distinguishing whether the network node is authorized or not by having an internet protocol address and a media access control address of the ARP packet to be compared with a permission list, and then for permitting the network node to connect with the network segment or for blocking off the network node. Thereby the network system can be protected and the safety of the network in use increases.

### FIELD

The present invention relates to a method for distinguishing and blocking off a network node, and more particularly to a method for distinguishing and blocking off a network node according to a permission list.

### BACKGROUND

Computer network is commonly used and thus the convenience of information exchange enhances. However, there are some risks of the information exchange in the network that affect the personal rights or the business interests. For example, personal financial data of electrical business may be stolen, and the computer system may be intruded by hackers to cause further data leakage, computer virus, file corrupting, and even system failure.

Receiving packets from network is risky, particularly to receiving a network packet from a malicious network node, such as an external computer with virus. The network packet from the malicious network node may cause other computers damages by means of wiretapping, tampering, virus attack, denial of service, or phishing, and such damages are very difficult to be prevented from. It becomes an important issue regarding how to plan strategy processes for improving network safety and for preventing from those damages.

### SUMMARY

The network risks are closely relative to a network node which sends network packets and is the source of the network packets. It thus is helpful to exactly evaluate the network node for promoting the network safety.

Accordingly, an aspect of the present invention is to provide a method for distinguishing and blocking off a network node for evaluating the network node sending the network packet, and for blocking off the unauthorized network node to solve the problems of damages.

The method comprises a packet receiving step and a packet distinguishing processing step. The packet receiving step is provided for receiving an ARP packet from a network node within a network segment. The packet distinguishing processing step is provided for distinguishing whether the network node is authorized or not by having an internet protocol address and a media access control address of the ARP packet to be compared with a permission list, and then for permitting the network node to connect with the network segment while the network node is distinguished as authorized or for blocking off the network node while the network node is distinguished as unauthorized.

According to an embodiment of the present invention, the permission list includes a temporary permission list and a permanent permission list.

According to an embodiment of the present invention, in the packet distinguishing processing step, the permission list for distinguishing the network node as authorized includes items selected from a group comprises: one media access control address, a media access control address together with a dynamic internet protocol address, a media access control address together with a static internet protocol address, one media access control address together with a plurality of internet protocol addresses, and one internet protocol address together with a plurality of media access control addresses.

According to an embodiment of the present invention, it further comprises, after the packet receiving step, a packet classifying step including a GARP sub step and an ARP requesting sub step.

According to an embodiment of the present invention, in the GARP sub step, the event of the network node is determined as an illegal IP grabbing event while a dynamic function is enabled and the ARP packet is a GARP packet whose the internet protocol address is in the permission list and is a dynamic internet protocol address that is changed from a static internet protocol address, and wherein the event of the network node is determined as an illegal IP grabbing event while the dynamic function is not enabled, and when the event of the network node is determined as an illegal IP grabbing event, the network node is blocked to prevent the network node from getting an internet protocol address in the permission list, and the internet protocol address and the media access control address in the permission list are broadcasted over the network segment.

According to an embodiment of the present invention, the ARP requesting sub step is sending a packet pretending itself as a source packet of a source network node to a target network node and sending a packet pretending itself as a target packet of the target network node to the source network node.

According to an embodiment of the present invention, the usage time and the authority limits of the network node are determined according to the temporary permission list and the permanent permission list.

According to an embodiment of the present invention, in the packet distinguishing processing step, a page redirecting information is sending to the network node while the network node is unauthorized.

By means of technical means of the present invention, the unauthorized network node is interdicted to send a network packet in a network segment by having an internet protocol address and a media access control address of an ARP packet of the network node to be compared with the permission list. Thereby the confidentiality, the integrity, the usability of the information exchange can be ensured. The network system can be protected. So the safety of the network in use is further raised. The method of the present invention is strict, effective, and suitable for applying in the personal network system and business network system.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a flowchart illustrating the method for distinguishing and blocking off a network node according to the first embodiment of the present invention;

FIG. 2 is a schematic diagram illustrating one network monitoring device performing the method for distinguishing and blocking off a network node according to the first embodiment of the present invention;

FIG. 3 is a schematic diagram illustrating one redirecting page according to the first embodiment of the present invention;

FIG. 4 is a flowchart illustrating the method for distinguishing and blocking off a network node according to the second embodiment of the present invention;

FIG. 5 is a flowchart illustrating the GARP distinguishing step according to the second embodiment of the present invention;

FIG. 6 is a flowchart illustrating the permission list protecting step according to the second embodiment of the present invention;

FIG. 7 is a flowchart illustrating the ARP requesting sub step according to the second embodiment of the present invention.

### DETAILED DESCRIPTION OF THE PREFERRED EMBODIMENTS

### The First Embodiment

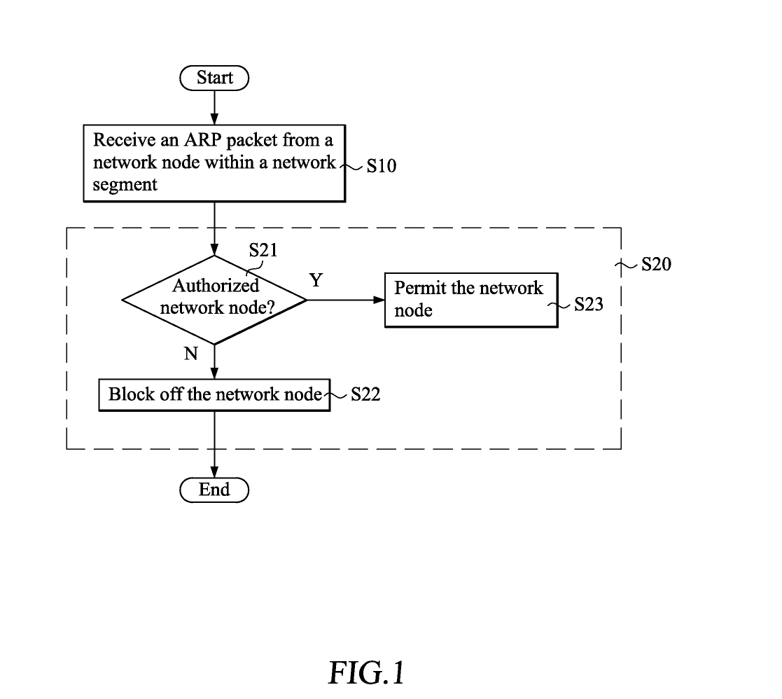

The invention provides a method for distinguishing and blocking off a network node that distinguishes a network node whether the network node is authorized or not according to the legality of an ARP (address resolution protocol) packet within a network segment and blocks off the network node according to the authorization of the network node. Refer to FIGS. 1-3. The method for distinguishing and blocking off a network node of the first embodiment according to the present invention is described as follows.

As shown in FIG. 1. FIG. 1 is a flowchart illustrating the method for distinguishing and blocking off a network node according to the first embodiment of the present invention. The method of the first embodiment includes a packet receiving step and a packet distinguishing processing step. First, the packet receiving step is executed (Step S10). Then, the packet distinguishing processing step is executed (Step S20). In the packet distinguishing processing step (Step S20), it distinguishes whether the network node is authorized or not by having an IP (internet protocol) address and a MAC (media access control) address of the ARP packet to be compared with a permission list (Step S21), and then blocks off the network node while the network node is unauthorized (Step S22), or permits the network node to connect with the network segment while the network node is authorized (Step S23).

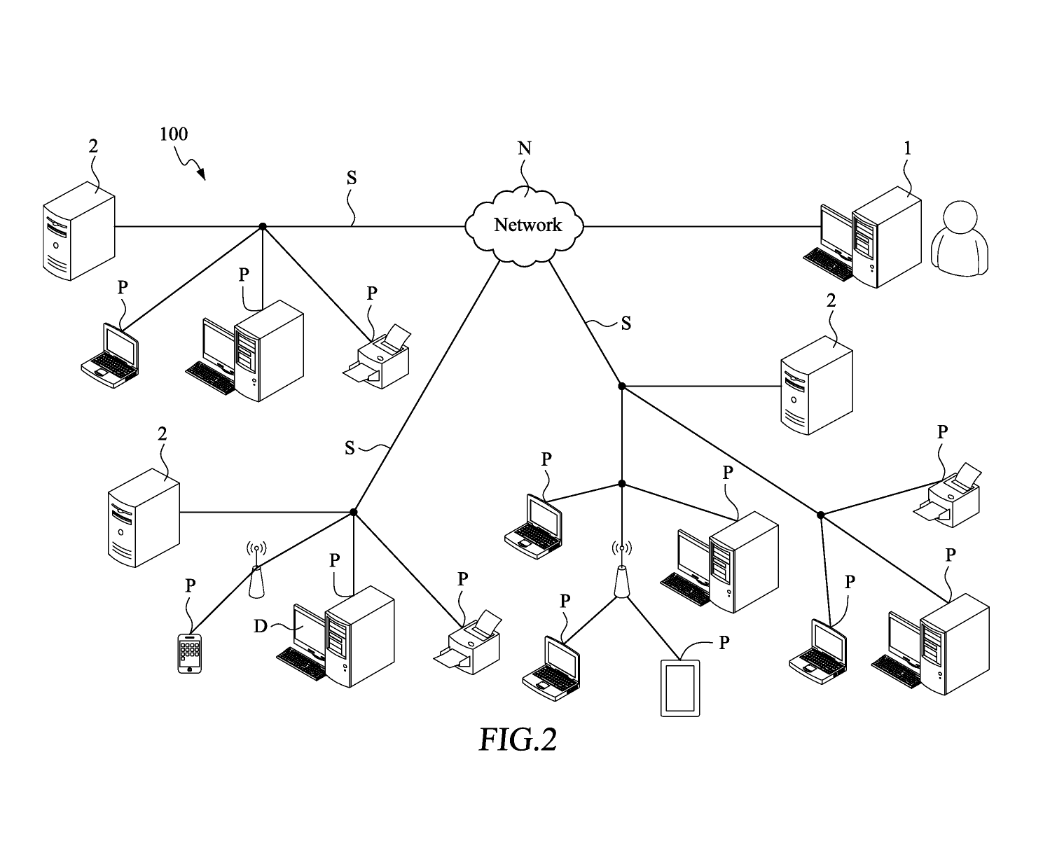

In the embodiment, a network monitoring device 100 is used to perform the method for distinguishing and blocking off a network node of the present invention, as shown in FIG. 2. The network monitoring device 100 includes a policymaking means 1 and an executing means 2. The policymaking means 1 and the executing means 2 are respectively computers or the likes. In general, one policymaking means 1 connects with a plurality of executing means 2 via a network N, and each executing means 2 connects with a plurality of network nodes P within a network segment S via the network N. The network node P can be a specific device, such as a computer, a smart phone, or a PDA (personal digital assistant), which connects to the network N by means of a network card, a wireless network card, or a wireless base station.

Specifically, in the packet receiving step, the executing means 2 retrieves the ARP packets sent from every network node P for monitoring a plurality of network nodes P within a network segment S. In the packet distinguishing processing step, the executing means 2 has the IP address and the MAC address of the ARP packet sent from every network node P to be compared with a permission list stored in the policymaking means 1, and distinguishes whether the ARP packet is legal or illegal according to the result of the comparison. And then the executing means 2 permits the network node P to connect with the network segment S monitored by the executing means 2 while the ARP packet from the network node P is legal or blocks off the network node P to send the ARP packet to the network segment S while the ARP packet from the network node P is illegal.

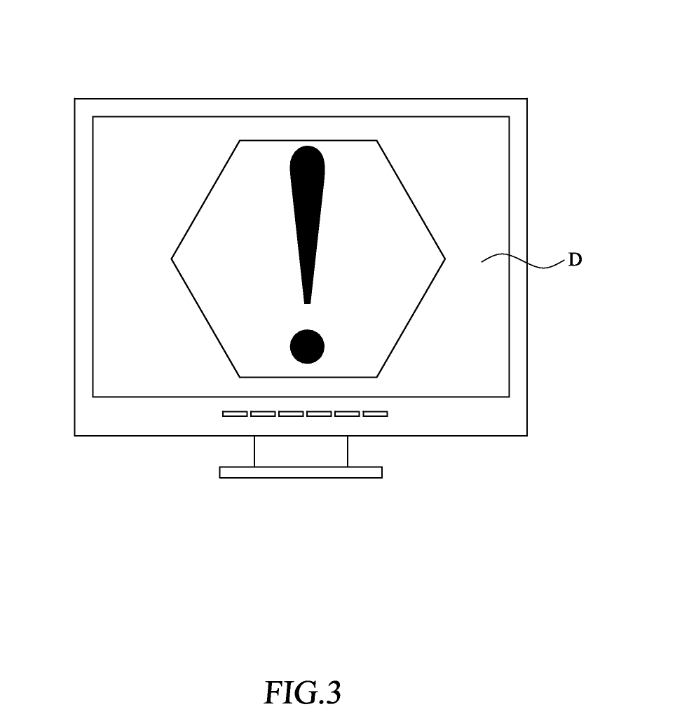

In addition to block off the network node P to send the ARP packet to the network segment S, the executing means 2 further sends a page redirecting information to the network node P while the ARP packet from the network node P is illegal, so that a screen D connected with the network node P shows a redirecting page. The redirecting page can be an advisory page, as shown in FIG. 3. Thereby the user who uses the network node P can be warned by noticing that the behavior of sending the ARP packet violates the utilization policy made in the policymaking means 1. The redirecting page also can be a registering page for allowing the unauthorized network node to become an authorized network node by registering.

In the packet distinguishing processing step, the permission list for distinguishing the network node as authorized includes items selected from a group comprises: one media access control address, a media access control address together with a dynamic internet protocol address, a media access control address together with a static internet protocol address, one media access control address together with a plurality of internet protocol addresses, and one internet protocol address together with a plurality of media access control addresses.

Furthermore, the permission list stored in the policymaking means 1 includes a temporary permission list and a permanent permission list. And the executing means 2 sets the usage time and the authority limits of the network node P within the network segment S according to the temporary permission list and the permanent permission list, wherein the usage time and the authority limits of the network node are determined according to the temporary permission list and the permanent permission list. In detail, while an IP address and a MAC address of a specific network node are corresponding to the temporary permission list stored in the policymaking means 1, the executing means 2 only permits the network node P to send the ARP packet to the network segment S which is monitored by the executing means 2 only within a limited period. While an IP address and a MAC address of another network node are corresponding to the permanent permission list stored in the policymaking means 1, the usage time of network node P for sending the ARP packet to the network segment S monitored by the executing means 2 is not limited by the executing means 2. However, when the executing means 2 detects that there is a presetting time that a ARP packet is not sent from the network node P, the executing means 2 will send a usage state signal to the policymaking means 1 for allowing the policymaking means 1 to delete the IP address and the MAC address of the network node P from the permanent permission list, thereby the user of the network monitoring device 100 will not spend too much time for maintaining the permanent permission list. In the condition that the method for distinguishing and blocking off a network node of the present invention is achieved in a company, the temporary permission list can be provided for provisional users, such as guests and short-term stagnation staffs, and the permanent permission list can be provided for supervisors and formal staffs, etc.

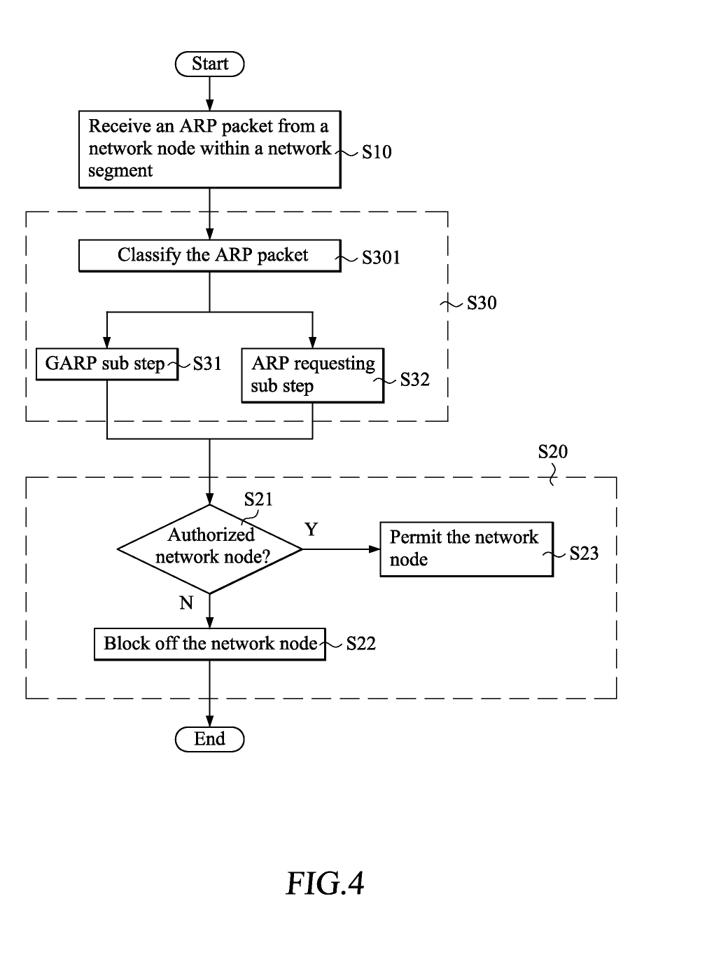

Refer to FIGS. 4-6 and FIG. 2. The method for distinguishing and blocking off a network node according to the second embodiment of the present invention is described as follows.

The method of the second embodiment is different from the method of the first embodiment in follows. In the embodiment, it further includes a packet classifying step (Step S30) between the packet receiving step and the packet distinguishing processing step. First, the ARP packet is classified as GARP (generic attribute registration protocol) packet, ARP requesting packet, or ARP replying packet (Step S301). Then, the packet classifying step further includes a GARP sub step (Step S31) for processing the GARP packet and an ARP requesting sub step (Step S32) for processing the ARP requesting packet, respectively. However, the present invention is not limited to that. The GARP sub step (Step S31) and ARP requesting sub step (Step S32) can be performed in any time after Step S10.

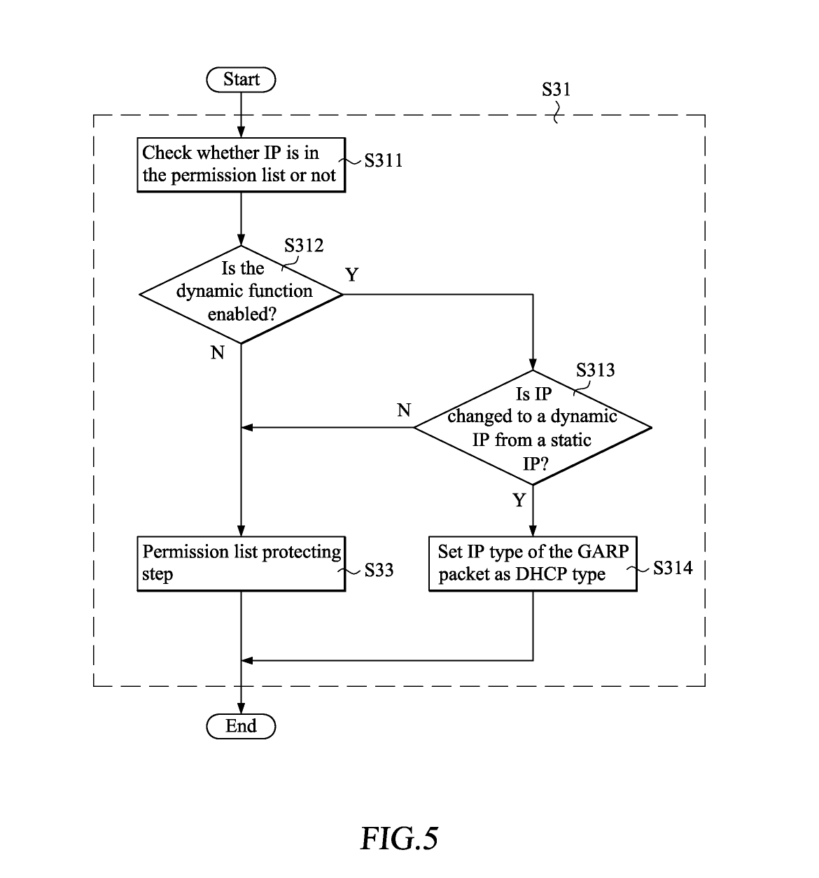

As shown in FIG. 5, the GARP sub step (Step S31) is described in detail as follows. First, the executing means 2 checks whether an IP address of the GARP packet is in the permission list or not (Step S311). While the IP address of the GARP packet is in the permission list, the executing means 2 checks whether a dynamic function in the policymaking means 1 is enabled or not (Step S312). While the dynamic function in the policymaking means 1 is enabled, the executing means 2 checks whether the IP address is a dynamic IP address that is changed from a static IP address (Step S313). While the dynamic function in the policymaking means 1 is enabled and IP address of the GARP packet is in the permission list and the IP address is a dynamic IP address that is changed from a static IP address, the event of the network node is determined as an illegal IP grabbing event and the IP type of the GARP packet is set as DHCP (dynamic host configuration protocol) type by the executing means 2 (Step S314). And the dynamic function in the policymaking means 1 is not enabled and the IP address of the GARP packet is in the permission list, the event of the network node is determined as an illegal IP grabbing event by the executing means 2.

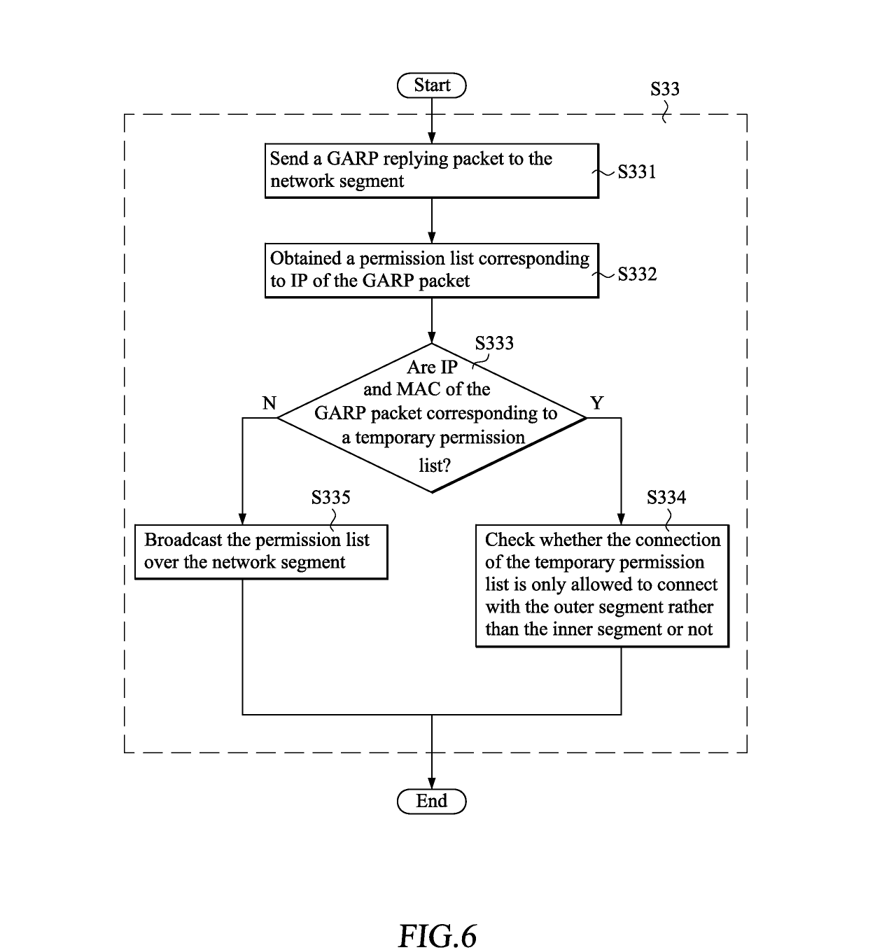

While the event of the network node is determined as an illegal IP grabbing event by the executing means 2, a permission list protecting step is performed (Step S33). As shown in FIG. 6, the permission list protecting step is described in detail as follows. A GARP replying packet is sent to the network segment S (Step S331) to prevent the network node from getting an IP address in the permission list. Then, a permission list corresponding to the IP address of the GARP packet is obtained (Step S332). While the MAC address of the GARP packet is in the permission list corresponding to the IP address of the GARP packet, the executing means 2 distinguishes whether the IP address and the MAC address of the GARP packet are corresponding to the temporary permission list or not (Step S333). Then, while the IP address and the MAC address of the GARP packet are corresponding to the temporary permission list, the executing means 2 checks whether the policymaking means 1 limits the connection of the members in the temporary permission list is only allowed to connect with the outer segment rather than the inner segment or not (Step S334). While the connection of the members in the temporary permission list is not limiting to only connect with the outer segment that is out of the inner segment, or while the IP address and the MAC address of the GARP packet are not corresponding to the temporary permission list, the IP address and the MAC address in the permission list are broadcasted over the network segment S against the network node P (Step S335).

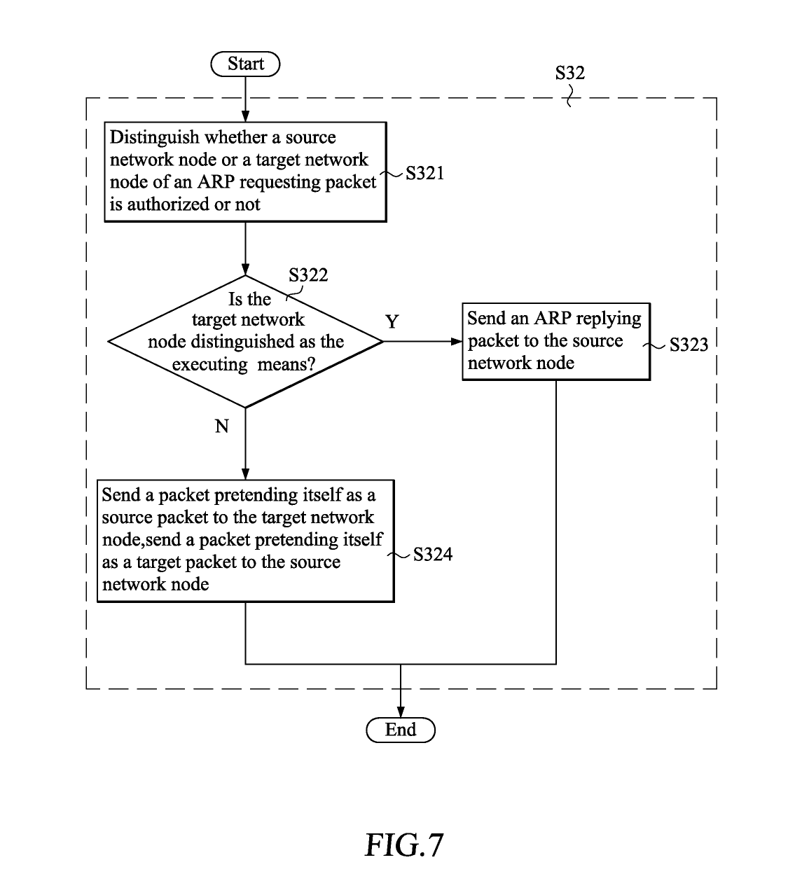

As shown in FIG. 7, the ARP requesting sub step (Step S32) is described in detail as follows. The executing means 2 distinguishes whether the source network node or the target network node of the ARP requesting packet is authorized or not (Step S321). While the source network node or the target network node of the ARP requesting packet is authorized, the executing means 2 distinguishes whether the target network node of the ARP requesting packet is the executing means 2 or not (Step S322). While the target network node of the ARP requesting packet is the executing means 2, an ARP replying packet is sent to the network node of the ARP requesting packet (Step S323). While the target network node of the ARP requesting packet is not the executing means 2, the executing means 2 sends a packet pretending itself as a source packet of a source network node to a target network node of the ARP requesting packet and sends a packet pretending itself as a target packet of the target network node to the source network node of the ARP requesting packet (Step S324).

The above description should be considered as only the discussion of the preferred embodiments of the present invention. However, a person skilled in the art may make various modifications to the present invention. Those modifications still fall within the spirit and scope defined by the appended claims.

What is claimed is:

1. A method for distinguishing and blocking off a network node, for distinguishing whether the network node is authorized or not according to an ARP packet within a network segment and for blocking off the network node which is distinguished as unauthorized, the method comprising steps of:
A packet receiving step for receiving the ARP packet from the network node within the network segment; and
A packet distinguishing processing step for distinguishing whether the network node is authorized or not by having an internet protocol address and a media access control address of the ARP packet to be compared with a permission list, and then for permitting the network node to connect with the network segment while the network node is distinguished as authorized or for blocking off the network node while the network node is distinguished as unauthorized.

2. The method for distinguishing and blocking off a network node as claimed in claim 1, wherein the permission list includes a temporary permission list and a permanent permission list.

3. The method for distinguishing and blocking off a network node as claimed in claim 1, wherein in the packet distinguishing processing step, the permission list for distinguishing the network node as authorized includes items selected from a group comprising: one media access control address, a media access control address together with a dynamic internet protocol address, a media access control address together with a static internet protocol address, one media access control address together with a plurality of internet protocol addresses, and one internet protocol address together with a plurality of media access control addresses.

4. The method for distinguishing and blocking off a network node as claimed in claim 1, further comprising, after the packet receiving step, a packet classifying step including a GARP sub step and an ARP requesting sub step.

5. The method for distinguishing and blocking off a network node as claimed in claim 4, wherein in the GARP sub step, the event of the network node is determined as an illegal IP grabbing event while a dynamic function is enabled and the ARP packet is a GARP packet whose the internet protocol address is in the permission list and is a dynamic internet protocol address that is changed from a static internet protocol address, and wherein the event of the network node is determined as an illegal IP grabbing event while the dynamic function is not enabled, and when the event of the network node is determined as an illegal IP grabbing event, the network node is blocked to prevent the network node from getting an internet protocol address in the permission list, and the internet protocol address and the media access control address in the permission list are broadcasted over the network segment.

6. The method for distinguishing and blocking off a network node as claimed in claim 4, wherein the ARP requesting sub step is sending a packet pretending itself as a source packet of a source network node to a target network node and sending a packet pretending itself as a target packet of the target network node to the source network node.

7. The method for distinguishing and blocking off a network node as claimed in claim 2, wherein the usage time and the authority limits of the network node are determined according to the temporary permission list and the permanent permission list.

8. The method for distinguishing and blocking off a network node as claimed in claim 1, wherein in the packet distinguishing processing step, a page redirecting information is sending to the network node while the network node is unauthorized.
